(19) United States
(12) Patent Application Publication
(10) Pub. No.: US 2018/0332004 A1
(43) Pub. Date: Nov. 15, 2018

(54) Camera and instrument double firewall apparatus and method of operation

(71) Applicants: Dean Drako, Austin, TX (US); Hans Kahler, Austin, TX (US)

(72) Inventors: Dean Drako, Austin, TX (US); Hans Kahler, Austin, TX (US)

(21) Appl. No.: 15/338,714

(22) Filed: May 15, 2017

(51) Int. Cl. H04L 29/06; H04N 7/18

(52) U.S. Cl. CPC H04L 63/0218; H04L 63/0245; H04L 67/30; H04L 63/0428; H04N 7/181; H04L 63/1408

(57) ABSTRACT

A cyber firewall for electronic instruments e.g. cameras isolates embedded controllers from hacking and hijacking. Positioned between a public wide area network and an exclusive private LAN, a bridge blocks emissions to untrusted recipients as well as cyber attacks on other networks. A routing component approves or suppresses traffic across the bridge by transforming IP addresses. A detection component transforms packet content by signing, suppressing, or encrypting according to a profile. The double firewall stops a camera from leaking images or being slaved into an attack bot. A system and architecture isolates image and instrument streams from other network traffic and interrupts, examines, and protects the content from unrecognized recipients. A dual system isolates cameras and other devices from a transaction-type network. When an instrument attempts any “extra” communications with the outside world the sender is disconnected, disabled, repaired and or replaced and the content transformed.

### CROSS-REFERENCE TO RELATED APPLICATIONS

None.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

### Not Applicable.

### BACKGROUND OF THE INVENTION

### Technical Field

The disclosure relates to computer network security.

As is known, hostile actors may cause devices owned by others and installed within their premises to transmit on a public wide area network.

Background: As is known a large number of phones, cameras, household appliances, electronic instruments, sensors, and their chipsets are designed and manufactured world-wide and by state controlled companies. Corruption of a supply chain is increasingly worrisome. The supply chain, software updates, and provisioning of image capture and other devices is susceptible to hidden or insertion of malicious circuits, firmware, and software. There is growing concern around Internet of things devices being corrupted, attacked or providing a doorway into a network. In particular cameras which are manufactured overseas are exposed to potential trojan horse software.

What is needed is a solution to prevent system owners from being harmed by their own investments in entertainment, convenience, automation, and surveillance security.

### BRIEF SUMMARY OF INVENTION

A network system prevents uncontrolled data or video images from leaking out of a private automation and surveillance system. The system includes a cyber firewall to stop cameras and other instruments from phoning home and being hacked. A device and architecture isolates image and data streams from other network traffic and interrupts, examines, and protects the content from unrecognized recipients. A dual system isolates cameras and other devices from the primary network. When the cameras attempt any “extra” communications with the outside world an apparatus operates on the network itself. In this case the offending camera can be disconnected, disabled, repaired and or replaced and the content discarded or transformed.

The apparatus supports a separation from a public WAN by creating private network called the CAMLAN.

More generally device metrics and automation commands (things) are isolated from user oriented applications such as web browsing, messaging, and database transactions by connection to a Sensor Controller Instrumentation Partitioned Network (SCIPnet). A bridge provides two subsystems to contain leakage and intrusion on devices coupled to the SCIPnet.

Cameras are placed on the CAMLAN either physically or through a wireless VPN. The bridge includes two processes for the detection of cameras operating out of their desired role, e.g. trying to “phone home” and reach out to the Internet. The first process is a routing process that identifies compliant normal communication and routes it to the programs and services that are trusted. The second process is a detection process that analyzes and disposes content addressed to untrusted or unknown recipients.

A double cyber firewall for cameras isolates security surveillance cameras from hacking and hijacking.

Positioned between public wide area network and an exclusive camera LAN, a bridge blocks emissions to untrusted recipients as well as cyber attacks on other networks.

A routing component approves or suppresses traffic across the bridge by transforming IP addresses.

A detection component transforms packet content by signing, suppressing, or encrypting according to a profile.

The system protects devices too simple to support anti-malware, anti-hijacking resources for themselves or which have been compromised during a manufacturing process.

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIGS. 1-2 are block diagrams of the system and components of apparatus embodiments;

FIG.3-5 are flow charts of method embodiments; and

FIG. 6 is a block diagram of a processor suitable for performing a method embodiment of the invention.

### DETAILED DESCRIPTION OF INVENTION

An apparatus isolates cameras from a primary computer network and detects when the cameras attempt any “extra” communications with the outside world. In this case the offending camera can be disconnected, disabled, repaired and or replaced.

The apparatus (bridge) further enables a separation from the WAN by providing an interface to a private network dedicated exclusively to a camera local area network (CAMLAN).

A CAMLAN may be virtual or physical and can connect wireless cameras through an encrypted channel.

All cameras are coupled to the bridge via the CAMLAN. The bridge includes circuits for the detection of cameras trying to “phone home” and reach out to the Internet external to a trusted profile. The first process is a routing process that takes all normal communication and routes it to the programs that are normally communicating with the camera.

All other communications is routed to the detection module. The detection module analyzes any outbound traffic initiated by any device on the CAMLAN and if it is unusual creates an ALERT to the operator via signaling methods of the user interface either locally or remotely. Examples of signaling include GUI types of alerts, notifying an operator by at least one of MMS message, email, recorded phone message, popup, sound or vibration on mobile application.

Even if a device is sending to a recipient appropriate to its usage, the detection module intercedes if the pattern of traffic is disruptive or the content is inconsistent with the intended purpose.

The cameras will operate normally streaming video and receiving command and control from the bridge and the Internet cloud service, however if the cameras attempt to do anything that is not part of this normal communications profile, the alert will be generated. Action can then be taken either manually or automatically. Such as shutting the camera down, powering it off, or placing it in a penalty box and stopping its video.

A routing component deflects attempts to externally control devices on the SCIPnet unless the commands come from known trusted secure sources. The routing component further suppresses or protects transmissions across the bridge according to compliance with a profile of trusted recipient services. When a device transmits to an unknown or untrusted recipient, the packets are rerouted to a detection module.

In an embodiment, the apparatus adds an additional encryption to content addressed to recipients not known to a profile and sends a key with the key to the operator. If the operator finds the content or recipient disreputable, the key is deleted. Any image file transmitted from the premises of the client on any device is passed through the EE bridge. This includes wireless devices that make use of the access points of the client.

A detection module examines packet contents that devices attempt to send across the bridge as well as the patterns of transmission. Content that is inconsistent with a recipient service or out of norm in size or activity is quarantined within the bridge or transformed to control both leakage and malicious traffic.

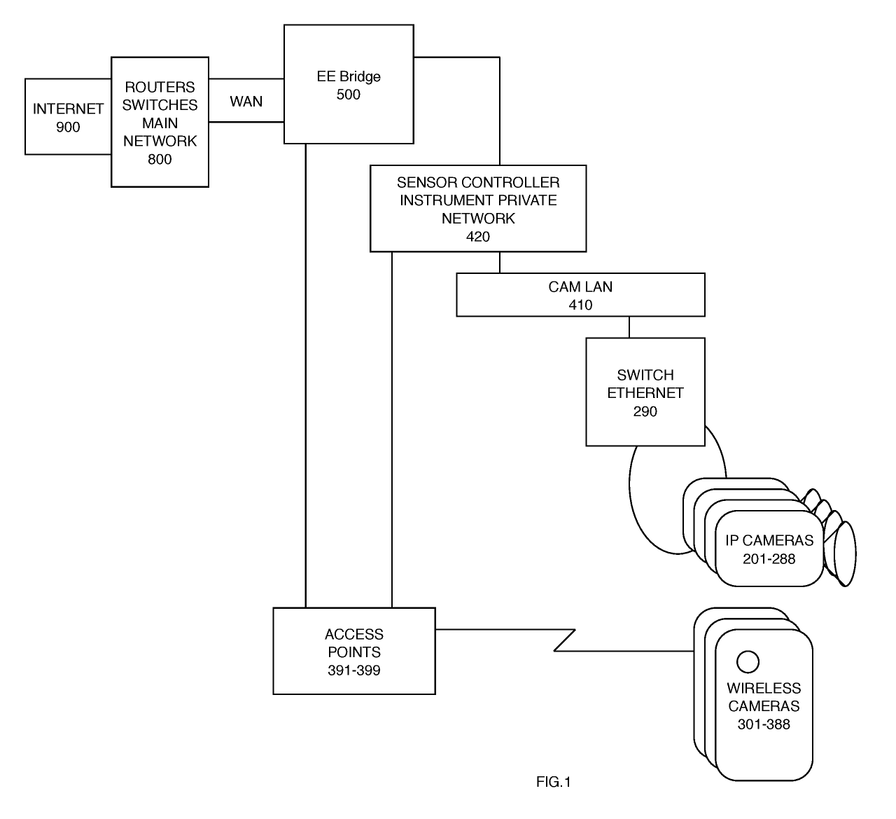

Referring to the FIG. 1: a bridge apparatus 500 is coupled to Internet servers and services 900 through conventional routers and switches 800 on a Wide Area Network (WAN). The EE bridge protects loss of control of images captured within and in the vicinity of a protected geolocation and proprietary network. A plurality of IP cameras 201-288 are communicatively coupled through a switch Ethernet cabling network into a Camera Local Area Network 410 which has thereby physically locates each camera. The CAMLAN is coupled to a private camera network 420 which is isolated from other services in the enterprise. Personal computers with cameras may also be attached to the private camera network 520. The EE Bridge 500 separates image traffic from non-camera related electronic messages and applications.

In an embodiment, a plurality of wireless cameras 301-388 may make use of access points 391-399 provided by the enterprise. The EE Bridge 500 distinguishes between image content traffic and non-image traffic. The non-image traffic can be routed to its normal recipient. The image stream traffic captured on a wireless camera is routed to an analysis module and compared with profiles of trusted known recipients. Image content from wireless cameras are also transformed according to a profile. The transformations include deletion, forwarding, alerting, and encrypting.

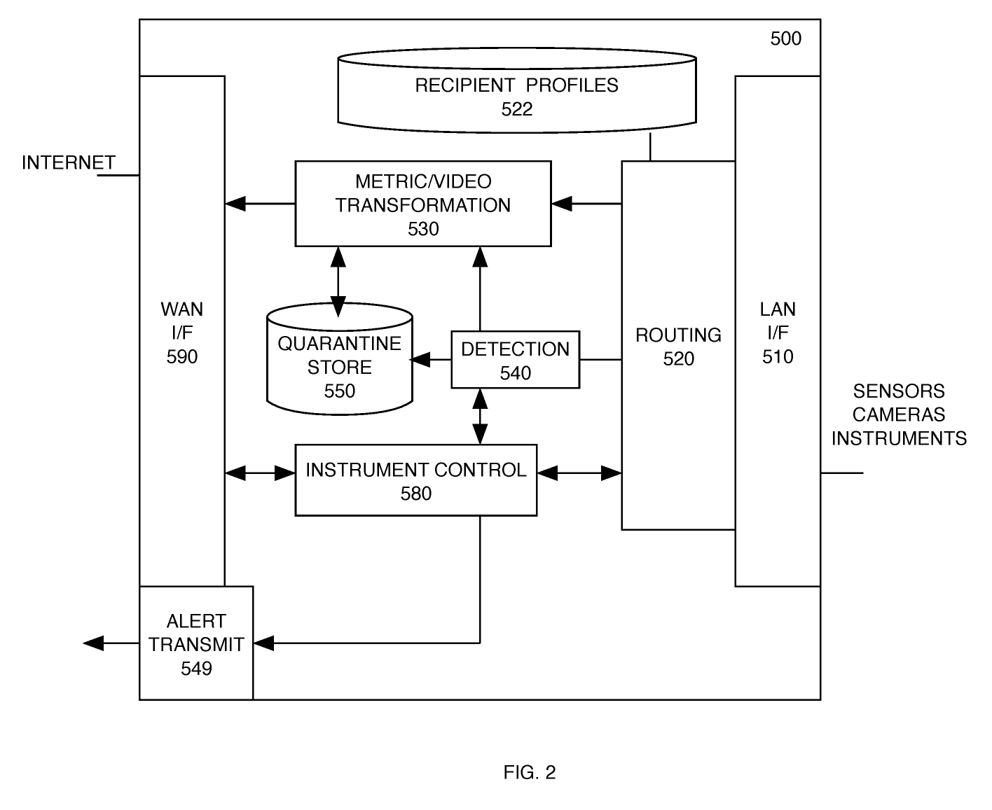

Referring to FIG. 2 the bridge apparatus 500 is coupled between a wide area network such as the Internet and an exclusive private local area network for cameras, sensors, instruments, actuators and other devices which are vulnerable to hacking or hijacking. The apparatus contain network interfaces to the local area network (LAN I/F) 510 and to the wide area network (WAN I/F) 590.

Essential components are a routing module 520 coupled to the LAN I/F, an instrument control module 580 coupled between the routing module 520 and the WAN I/F 590, and a detection module 540 coupled between the instrument control module 590 and the routing module 520. The modules include at least one processor or may share use of one or more processors or may be in virtual machines of a multicore processor.

The routing module is coupled to a non-transitory store 522 or recipient profiles which include IP addresses and the applications for which traffic is intended. The routing module will divert packets which do not match both the type content and a trusted recipient destination address to the detection module 540.

The detection module filters incoming commands presented to the instrument control module to prevent hijacking or hacking. The detection module causes the instrument control module 580 to switch modes of a device or reboot a device on the local area network if content or recipient addresses are inconsistent with trusted recipient profiles. In that event, a message will be sent to an administrative console through the alert transmitter 549. The detection module may cause output packets to be transformed in a metric/video transformation module 530 which is coupled between the routing module 520 and the WAN I/F 590. The detection module may cause output to be stored into a quarantine store 550 until a proper disposition is chosen by an operator.

The EE bridge contains a profile of trusted image recipients and message senders who may exchange traffic with each camera. Camera messages and image streams that are not trusted in the profile cause further processing. This includes deletion, and alerts to the operator. The camera may be electronically disconnected or rendered inoperative. The traffic may be encrypted for further security.

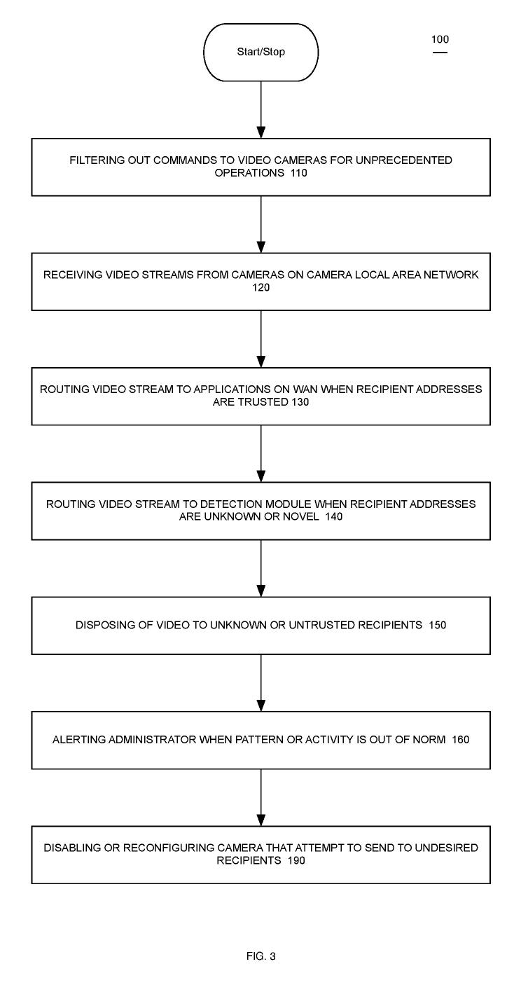

Referring to FIG.3, a method of operation 100 for a video image bridge includes: filtering out commands to video cameras for unprecedented operation 110; receiving video streams from cameras 120; routing video streams to applications on WAN when recipient addresses are trusted 130; routing video streams to a detection module for analysis when recipient addresses are unknown or novel 140; disposing of video streams to unknown or untrusted recipients by discarding or transforming images 150; alerting an administrator of non-normal activity or pattern 160; and disabling or reconfiguring cameras transmitting to undesired recipients 190.

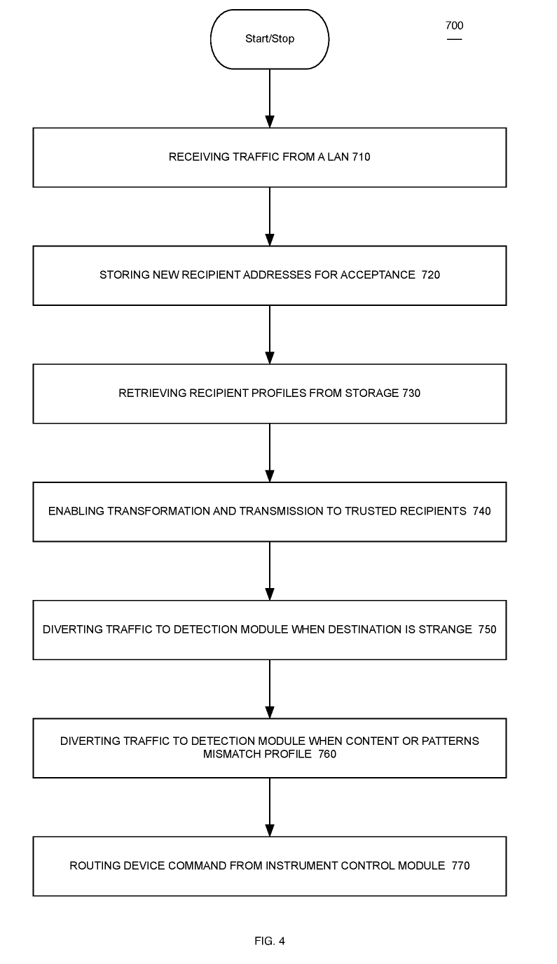

Referring to FIG. 4, a method of operation 700 for a routing module includes receiving traffic from a local area network interface 710; storing new recipient addresses into a history file for acceptance 720; retrieving recipient profiles stored in non-transitory store 730; enabling transformation and transmission of traffic to applications at trusted recipient addresses 740; diverting traffic to a detection module when a destination address is inconsistent with a trusted recipient profile 750; diverting traffic to a detection module when patterns or content is inconsistent with a trusted recipient profile 760; and routing device commands from the instrument control module 790.

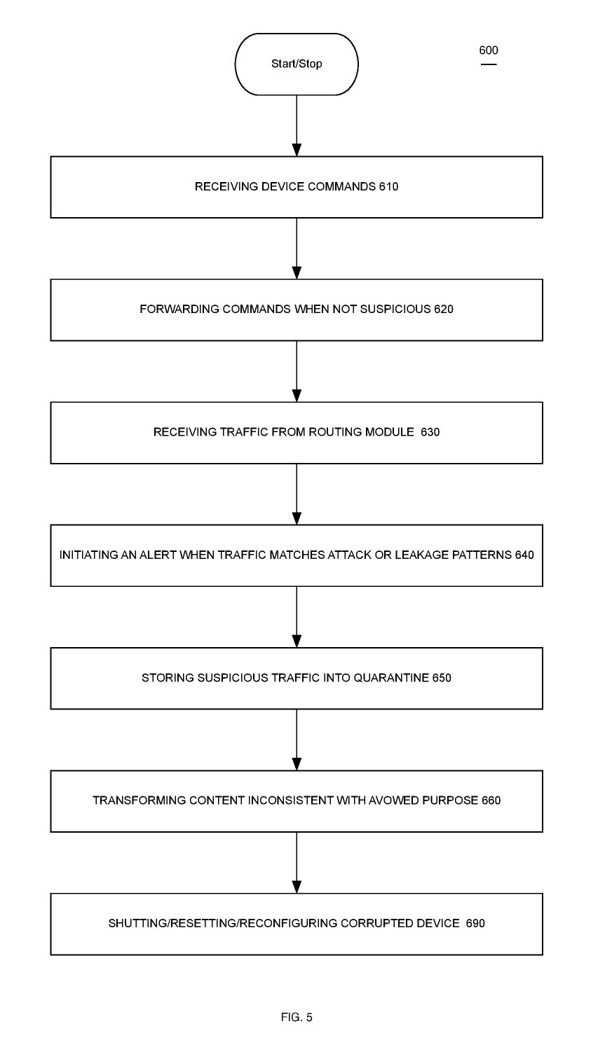

Referring to FIG. 5, a method of operation 600 for a detection module includes: receiving device commands originating from a wide area network 610; forwarding commands to devices when said commands are not suspicious 620; receiving traffic from a routing module 630; initiating an alert when traffic matches an attack pattern or a data leakage pattern 640; causing storage into quarantine store when traffic is suspicious 650; causing a transformation of traffic when traffic is inconsistent with intended purpose 660; and shutting/restarting/rebooting a device when traffic content is inconsistent with a recipient profile 590.

Known trusted recipients of image streams are served via a VPN. Image streams targeted to recipients unknown to the operator are transformed. In an embodiment, a facility owner transforms content being transmitted out of his network using “ransom-ware” and upon later verification of the recipient, enables viewing of the images by providing a key. In an embodiment, detection of attacks on other networks are suppressed by dropping or rerouting packets to a botnet controller.

### EMBODIMENTS

One aspect of the invention can be enabled as a system to prevent cameras from transmitting to image streams or events out of an internal network to untrusted recipients. The system includes: an exclusive private camera network coupled between a bridge and a plurality of image capture device; a switched Ethernet Local Area Network coupled to the plurality of image capture devices; a circuit to identify image and non-image traffic passing into the bridge; a circuit to route outbound traffic from the cameras to recipients known to a profile to trusted network addresses; a circuit to alert an operator of inbound traffic to cameras from senders not known to the profile; a circuit to characterize traffic sent by a camera as content consistent with a profile addressed to a recipient consistent with the profile; a circuit to characterize traffic sent by a camera as inconsistent from a profile in either addressee or content; and a circuit to alert an operator when a camera attempts traffic inconsistent with its profile.

In an embodiment, the system includes: a circuit to transform content emitted by a camera for transmission to a recipient not known to the profile; and a circuit to transmit an alert and a transformation recovery key to an operator.

Another aspect of the invention is a processor executable method of operation for a camera firewall bridge apparatus including: transforming messages intended for a camera isolated from the public network according to a profile of trusted messages senders by relaying, discarding, and alerting a user; determining if transmissions from a camera isolated by the apparatus from the public network is compliant with a profile for image streams and messages; routing messages outbound from a camera to recipients known to a profile; routing image streams outbound from a camera to an analysis module; routing image streams from a camera to a recipient consistent with a profile; and transforming image streams addressed to a recipient inconsistent with or not yet known to a profile and notifying an operator.

In an embodiment, the method includes: deleting an image stream addressed to said recipient.

In an embodiment, the method includes: encrypting said image stream.

In an embodiment, the method includes: providing an operator with an alert and an encryption reversal code.

In an embodiment, the method includes: determining when a plurality of packets demonstrate an IP address hopping pattern; reporting an attack signature to a central security server; and restoring a camera to a trusted clean version of firmware.

Another aspect of the invention is as a video network bridge apparatus (bridge) coupled between a plurality of local area networked cameras and a public wide area network. Such a bridge may include: a malicious content detection circuit to enable or suppress transit of messages across the bridge; and a message routing circuit to transform message addresses to secure proprietary video intellectual property; a network interface to public networks; a network interface to a camera local area network; an encryption and compression circuit; a non-transitory store for computer readable files; and an alert and control circuit for attached cameras and remote operation.

In an embodiment, the malicious content detection circuit includes: a circuit to verify a command to an instrument is legitimate; a circuit to verify an update to firmware is legitimate; a circuit to distinguish normal from abnormal traffic patterns; a circuit to throttle traffic which exceeds a normal rate; a circuit to dispose of content that fails a pattern; a circuit to encrypt content directed to an unknown address and transmit an alert with a decryption key; and a circuit to disable an instrument which disrupts desired operations.

In an embodiment, the message routing circuit to transform message addresses to secure proprietary video intellectual property includes: a non-transitory store of verified IP addresses; a circuit to suppress incoming commands from unverified IP addresses; a circuit to suppress transmission to unverified IP addresses; a circuit to match type of content suitable for each verified IP address; a circuit to transform IP addresses on outgoing packets when content or IP address is not compliant with a profile; a circuit to transform IP addresses to a quarantine zone for malicious content detection when an original IP address is not trusted.

Another aspect of the invention is an intelligent location communications control system including: a processing and storage unit; a first network connection to an Internet service; a second network connection to at least one embedded controller within an electronic instrument; a non-transitory store of software that stores or transmits indicia from said embedded controller; a non-transitory store of software that detects and alerts when the embedded controller attempts communication to any Internet service; and a circuit to modify or block communication by the embedded controller.

In embodiments the electronic instrument is at least one of a thermostat; a temperature sensor; an electrical power panel; a smoke/carbon monoxide sensor; an entertainment center such as a television, a virtual reality or a game console; a door actuator such as for an overhead door or handicap entrance; an appliance such as a stove, oven, refrigerator, freezer, or laundry; or a security device such as motion sensing, closure, or a camera.

As is known, circuits disclosed above may be embodied by programmable logic, field programmable gate arrays, mask programmable gate arrays, standard cells, and computing devices limited by methods stored as instructions in non-transitory media.

Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

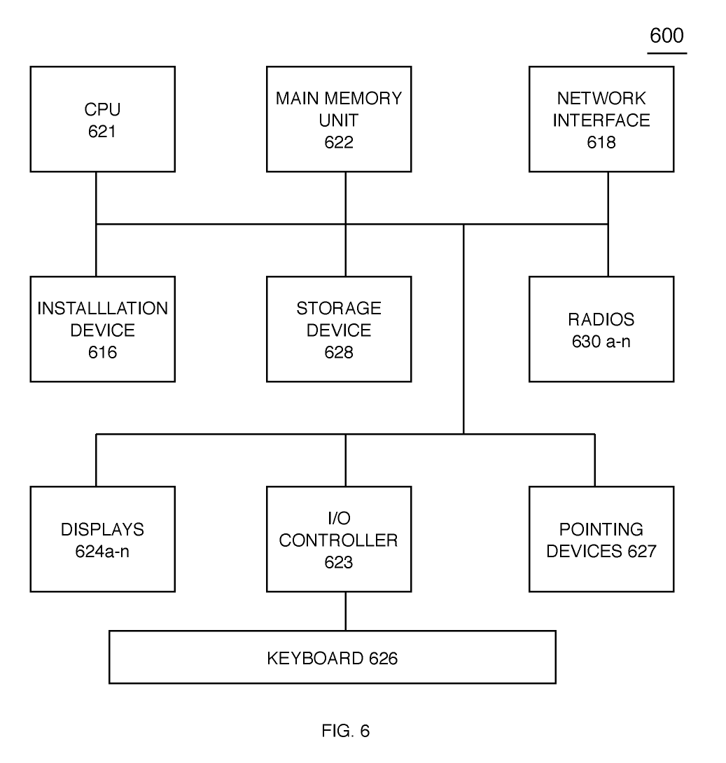

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG.6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10 and WINDOWS VISTA, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; Nokia of Finland; Hewlett-Packard Development Company, L.P. and/or; Sony Ericsson Mobile Communications AB of Lund, Sweden; or Alphabet of Mountain View Calif. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment', in another embodiment', and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

### Conclusion

The apparatus is easily distinguished from conventional firewalls by the dual processes of routing and detection. The apparatus is distinguished by preventing leakage of data such as images to undesired recipients as well as protecting external servers from attack from rogue cameras, sensors, controllers, and actuators.

Having described certain embodiments of methods and systems for restricting camera images to authenticated recipients, it will now become apparent to one of skill in the art that other embodiments incorporating the concepts of the disclosure may be used. Therefore, the disclosure should not be limited to certain embodiments, but rather should be limited only by the spirit and scope of the following claims.

1. A location communication control system comprising:
a processing and storage unit;
a first network connection to an Internet service;
a second network connection to at least one embedded controller within an electronic instrument;
a non-transitory store of software that stores or transmits indicia from said embedded controller;
a non-transitory store of software that detects and alerts when the embedded controller attempts communication to any untrusted Internet service; and
a circuit to modify or block communication by the embedded controller.

2. The system of claim 1 wherein an electronic instrument is at least one thermostat.

3. The system of claim 1 wherein an electronic instrument is at least one temperature sensor.

4. The system of claim 1 wherein an electronic instrument is at least one electrical power panel.

5. The system of claim 1 wherein an electronic instrument is at least one smoke/carbon monoxide sensor.

6. The system of claim 1 wherein an electronic instrument is at least one entertainment center.

7. The system of claim 1 wherein an electronic instrument is at least one game console.

8. The system of claim 1 wherein an electronic instrument is at least one garage door actuator.

9. The system of claim 1 wherein an electronic instrument is at least one kitchen appliance.

10. The system of claim 1 wherein an electronic instrument is at least one camera.

11. A system to prevent cameras from transmitting to image streams or events out of an internal network to untrusted recipients comprising:
an exclusive private camera network coupled between a bridge and a plurality of image capture device;
a switched Ethernet Local Area Network coupled to the plurality of of image capture devices;
a circuit to identify image and non-image traffic passing into the bridge;
a circuit to route outbound traffic from the cameras to recipients known to a profile to trusted network addresses;
a circuit to alert an operator of inbound traffic to cameras from senders not known to the profile;
a circuit to characterize traffic sent by a camera as content consistent with a profile addressed to a recipient consistent with the profile;
a circuit to characterize traffic sent by a camera as inconsistent from a profile in either addressee or content;
and a circuit to alert an operator when a camera attempts traffic inconsistent with its profile.

12. The system of claim 11 further comprising:
a circuit to transform content emitted by a camera for transmission to a recipient not known to the profile; and
a circuit to the transmit an alert and a transformation recovery key to an operator.

13. A method of operation for a camera firewall bridge apparatus comprising:
transforming messages intended for a camera isolated from the public network according to a profile of trusted messages senders by relaying, discarding, and alerting a user;
determining if transmissions from a camera isolated by the apparatus from the public network is compliant with a profile for image streams and messages;
routing messages outbound from a camera to recipients known to a profile;
routing image streams outbound from a camera to an analysis module;
routing image streams from a camera to a recipient consistent with a profile;
transforming image streams addressed to a recipient inconsistent with or not yet known to a profile; and
notifying an operator by at least one of MMS message, email, recorded phone message, popup, sound or vibration on mobile application.

14. The method of claim 13 further comprising:
deleting an image stream addressed to said recipient.

15. The method of claim 13 further comprising:
encrypting said image stream.

16. The method of claim 13 further comprising:
providing an operator with an alert and an encryption reversal code.

17. The method of claim 13 further comprising:
determining when a plurality of packets demonstrate an IP address hopping pattern;
reporting an attack signature to a central security server; and
restoring a camera to a trusted clean version of firmware.

18. A video network bridge apparatus (bridge) coupled between a plurality of local area networked cameras and a public wide area network, the bridge comprising:
a malicious content detection circuit to enable or suppress transit of messages across the bridge; and
a message routing circuit to transform message addresses to secure proprietary video intellectual property;
a network interface to public networks;
a network interface to a camera local area network;
an encryption and compression circuit;
a non-transitory store for computer readable files; and
an alert and control circuit for attached cameras and remote operation.

19. The video network bridge apparatus of claim 18 wherein said malicious content detection circuit comprises:
a circuit to verify a command to a camera is legitimate;
a circuit to verify an update to camera firmware is legitimate;
a circuit to distinguish normal from abnormal traffic patterns;
a circuit to throttle traffic which exceeds a normal rate;
a circuit to dispose of content that fails a pattern;
a circuit to encrypt content directed to an unknown address and transmit an alert with a decryption key; and
a circuit to disable a camera which disrupts desired operations.

20. The video network bridge apparatus of claim 18 wherein said message routing circuit to transform message addresses to secure proprietary video intellectual property comprises:
a non-transitory store of verified IP addresses;
a circuit to suppress incoming commands from unverified IP addresses;
a circuit to suppress transmission to unverified IP addresses;
a circuit to match type of content suitable for each verified IP address;
a circuit to transform IP addresses on outgoing packets when content or IP address is not compliant with a profile;
a circuit to transform IP addresses to a quarantine zone for malicious content detection when an original IP address is not trusted.
